(19) United States
(12) Patent Application Publication
(10) Pub. No.: US 2005/0270310 A1
(43) Pub. Date: Dec. 8, 2005

(54) Apparatuses and methods for incorporating a border within an image

(76) Inventor: Eric Jeffrey, Richmond (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/859,654

(22) Filed: Jun. 3, 2004

(51) Int. Cl. G06K 9/34; G06K 9/36

(52) U.S. Cl. 345/641

(57) ABSTRACT

A hardware implemented method for incorporating a border region within an image region is provided. In this hardware implemented method, a main image fetching circuit is accessed to determine a relative position of a pixel within the image region. Subsequently, an image pixel or a border pixel is fetched dependent upon the relative position of the pixel. An apparatus and display controllers for incorporating the border region within the image region also are described.

### BACKGROUND OF THE INVENTION

1. Field of the Invention

This invention relates generally to computer graphics and, more particularly, to methods and apparatuses for incorporating a border within an image.

2. Description of the Related Art

In computer graphics, a border is commonly placed around an image being displayed. FIG. 1 is an illustration of a conventional method to implement the border around the image. Currently, to place border 102 around image 106, a graphics controller must use an overlay 108 that is equal in size to the image. Overlay 108 includes border 102 and center area 104 that is programmed to be transparent. Thus, even though border 102 comprises only a portion of an area of image 106, the number of overlay pixels being stored equals the number of image pixels. In addition, extra circuitry is needed to process the transparent pixels in center area 104 within overlay 108, which consumes additional power and bandwidth.

As a result, many small, portable devices have problems processing a border overlay because these devices typically have limited power, memory, and computing capability. Since these devices are limited in their memory and computing power, processing the overlays may exceed the memory limitations and dominate the CPU cycles of these devices and, as a result, dramatically slow down the executed applications.

In view of the foregoing, there is a need to provide apparatuses and methods for reducing the memory requirements and CPU processing power required to implement a border.

### SUMMARY OF THE INVENTION

Broadly speaking, the present invention fills these needs by providing hardware implemented methods and an apparatus for incorporating a border region within an image region. It should be appreciated that the present invention can be implemented in numerous ways, including as a method, a system, or a device. Several inventive embodiments of the present invention are described below.

In accordance with a first aspect of the present invention, a hardware implemented method for incorporating a border region within an image region is provided. In this hardware implemented method, a main image fetching circuit is accessed to determine a relative position of a pixel within the image region. Next, an image pixel or a border pixel is fetched dependent upon the relative position of the pixel.

In accordance with a second aspect of the present invention, a hardware implemented method for incorporating a border region within an image region is provided. In this hardware implemented method, a relative position of a pixel within the image region is first computed. The relative position of the pixel is then compared with a border region width to determine whether the pixel is located in the border region. If the relative position of the pixel is in the border region, then a border pixel is fetched from a border memory. However, if the relative position of the pixel is in the image region, then an image pixel is fetched from a main memory.

In accordance with a third aspect of the present invention, a display controller for incorporating a border region within an image region is provided. The display controller includes a main memory configured to store an image pixel and a border memory configured to store a border pixel. The main memory and the border memory are in communication with a memory controller that is configured to fetch the image pixel from the main memory and to fetch the border pixel from the border memory. A main image fetching circuit is also in communication with the memory controller. The main image fetching circuit includes: logic for computing a relative position of a pixel within the image region; logic for fetching the border pixel from the border memory if the relative position of the pixel is in the border region; and logic for fetching the image pixel from the main memory if the relative position of the pixel is in the image region.

In accordance with a fourth aspect of the present invention, an apparatus for incorporating a border region within an image region is provided. The apparatus includes a display controller with circuitry for accessing a main image fetching circuit to determine a relative position of a pixel within the image region, and circuitry for fetching an image pixel or a border pixel dependent upon the relative position of the pixel. Additionally, a central processing unit (CPU) in communication with the display controller and a display in communication with the display controller are included.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is an illustration of a conventional method to implement a border around an image.

FIG. 2 is a flowchart diagram of a high level overview of a hardware implemented method for incorporating a border region within an image region, in accordance with one embodiment of the present invention.

FIG. 3 is a simplified schematic diagram of an apparatus for incorporating a border region within an image region, in accordance with one embodiment of the present invention.

FIG. 4 is a more detailed schematic diagram of the display controller shown in FIG. 3, in accordance with one embodiment of the present invention.

FIG. 5 is a more detailed block diagram of the main image fetching circuit shown in FIG. 4, in accordance with one embodiment of the present invention.

FIG. 6A illustrates a border region with a uniform border region width, in accordance with one embodiment of the present invention.

FIG. 6B illustrates a border region with a non-uniform border region width, in accordance with another embodiment of the present invention.

FIG. 7 illustrates a border region with non-linear edges, in accordance with one embodiment of the present invention.

FIG. 8 is a detailed schematic diagram of a display controller that can incorporate non-linear border edges, in accordance with one embodiment of the present invention.

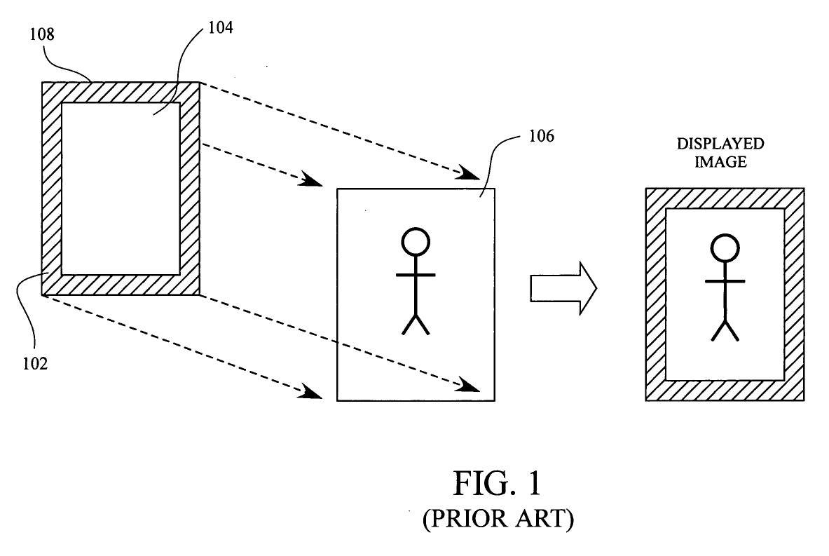

### DETAILED DESCRIPTION OF THE PREFERRED EMBODIMENTS

An invention is described for hardware implemented methods and an apparatus for incorporating a border region within an image region. It will be obvious, however, to one skilled in the art, that the present invention may be practiced without some or all of these specific details. In other instances, well known process operations have not been described in detail in order not to unnecessarily obscure the present invention.

The embodiments described herein provide an apparatus, display controllers, and hardware implemented methods for incorporating a border region within an image region. Essentially, instead of storing an entire overlay, only a portion of the overlay that comprises the border region is stored in memory. As will be explained in more detail below, to accommodate the display of a partial overlay, a display controller fetches an image pixel or a border pixel for display depending upon a relative position of a pixel.

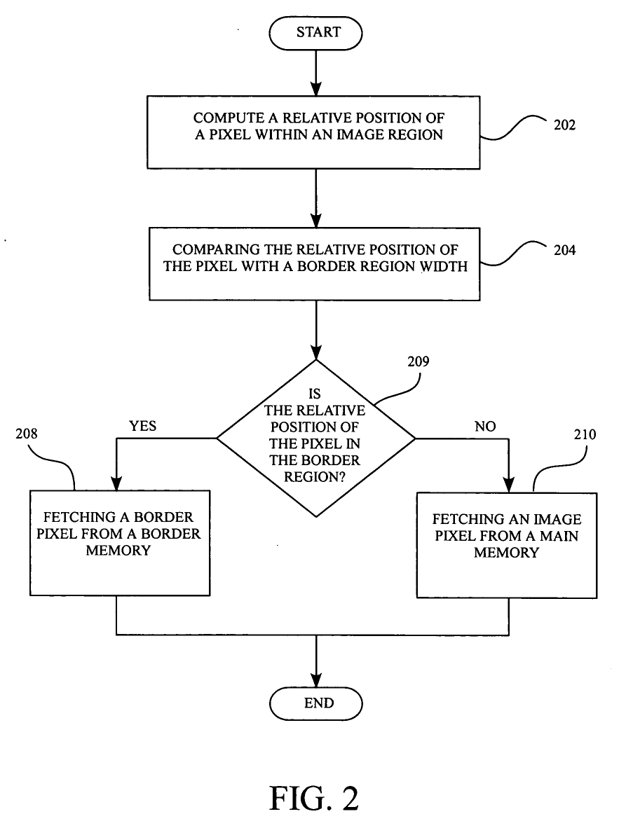

FIG. 2 is a flowchart diagram of a high level overview of a hardware implemented method for incorporating a border region within an image region, in accordance with one embodiment of the present invention. In one embodiment, a main image fetching circuit is accessed to determine a relative position of a pixel within the image region. As shown in FIG. 2, starting at operation 202, the relative position of the pixel is computed within the image region. As will be explained in more detail below, the relative position of the pixel is then compared with a border region width in operation 204 to determine whether the pixel is located in the border region. As shown in operation 209, dependent upon the relative position of the pixel, an image pixel or a border pixel is fetched. It should be appreciated that the border region is comprised of border pixels and represents a portion of an area of the image pixels. If the relative position of the pixel is in the border region, then the border pixel is fetched from a border memory in operation 208. However, if the relative position of the pixel is in the image region, then the image pixel is fetched from the main memory in operation 210. As a result, the main image fetching circuit fetches pixels that comprise the border region of the overlay, and not the transparent pixels within a center region of the overlay. The transparent pixels within the center region are therefore not stored in memory. Thus, there is no need to store the transparent pixels representing the center region in memory.

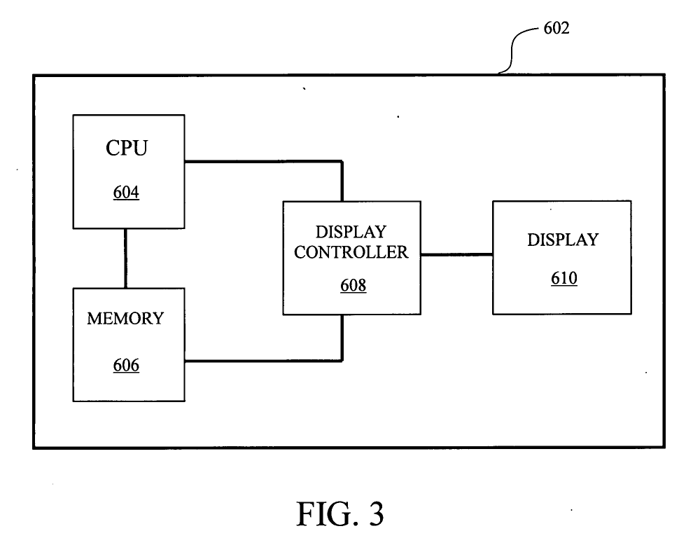

FIG. 3 is a simplified schematic diagram of an apparatus for incorporating a border region within an image region, in accordance with one embodiment of the present invention. Apparatus 602 includes any suitable type of computing device. For example, apparatus 602 may be a personal digital assistant, a cell phone, a web tablet, a pocket personal computer, etc. As shown in FIG. 3, apparatus 602 includes central processing unit (CPU) 604, memory 606, display controller 608, and display 610. Display 610 may include liquid crystal (LCD) displays, thin-film transistor (TFT) displays, cathode ray tube (CRT) monitors, televisions, etc. Examples of memory 606 include static access memory (SRAM), dynamic random access memory (DRAM), etc.

Display controller 608 is in communication with CPU 604, memory 606, and display 610. In one embodiment, pixels are stored in a memory included within display controller 608. In another embodiment, memory 606, which is in communication with CPU 604, may also be configured to store the pixels. One skilled in the art will appreciate that while CPU 604, memory 606, and display controller 608 are illustrated as being interconnected, each of these components may be in communication through a common bus.

The functionality described above for incorporating a border region within an image region is incorporated into display controller 608. In one embodiment, display controller 608 contains the circuitry for accessing a main image fetching circuit within display controller 608 to determine a relative position of a pixel within the image region, and circuitry for fetching an image pixel or a border pixel dependent upon the relative position of the pixel. Display 610 which is coupled to display controller 608, then displays the corresponding image pixels or border pixels.

It will be apparent to one skilled in the art that the functionality described herein may be synthesized into firmware through a suitable hardware description language (HDL). For example, the HDL (e.g., VERILOG) may be employed to synthesize the firmware and the layout of the logic gates for providing the necessary functionality described herein to provide a hardware implementation of the border region incorporation techniques and associated functionalities. Thus, the embodiments described herein may be captured in any suitable form or format that accomplishes the functionality described herein and is not limited to a particular form or format.

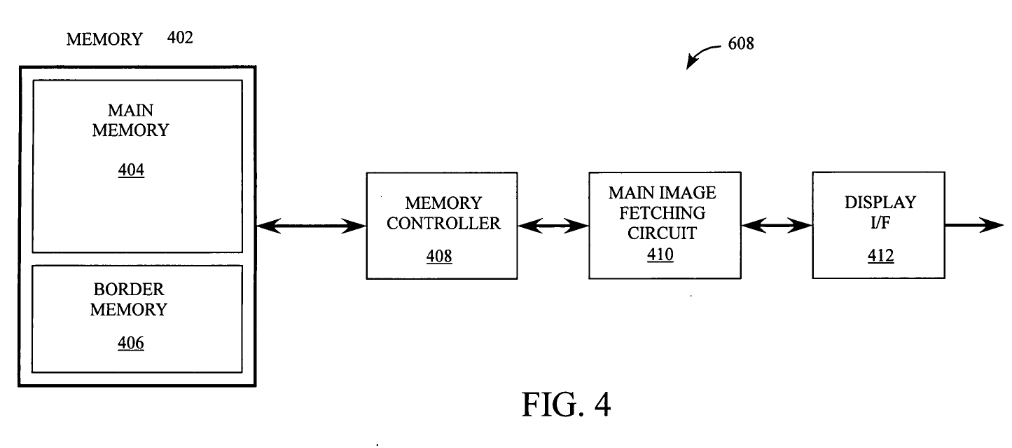

FIG. 4 is a more detailed schematic diagram of the display controller shown in FIG. 3, in accordance with one embodiment of the present invention. As shown in FIG. 4, display controller 608 includes memory 402, memory controller 408, main image fetching circuit 410, and display interface 412. Memory 402 includes any suitable type of memory such as SRAM, DRAM, etc. In one embodiment, memory 402 has separate main memory 404 and border memory 406 sections. Main memory 404 stores image pixels and border memory 406 stores border pixels. Alternatively, in another embodiment, display controller 608 may have separate memories to store the image pixels and the border pixels. Display interface 412, which is in communication with main image fetching circuit 410, provides an interface to a display.

Main image fetching circuit 410 includes logic for fetching an image pixel or a border pixel dependent upon the relative position of the pixel. For example, in one embodiment, main image fetching circuit 410 includes logic for fetching the border pixel from border memory 406 if the relative position of the pixel is in a border region. However, if the relative position of the pixel is in an image region, then main image fetching circuit 410 includes logic for fetching the image pixel from main memory 404.

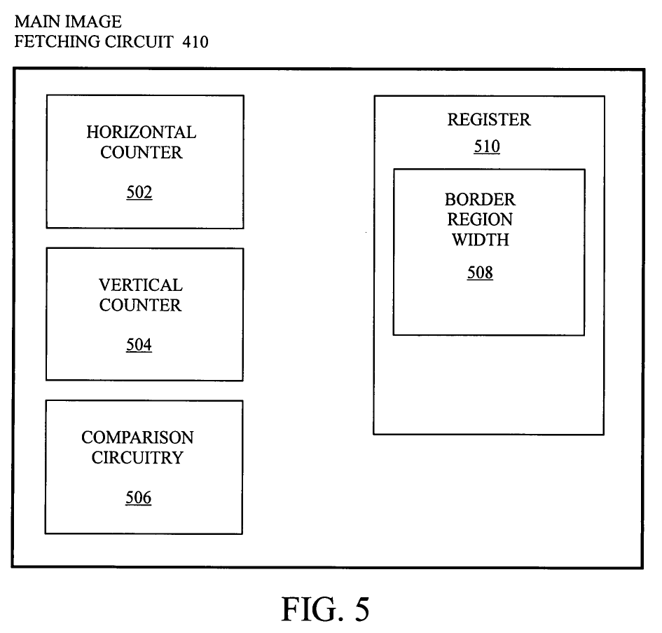

FIG. 5 is a more detailed block diagram of the main image fetching circuit shown in FIG. 4, in accordance with one embodiment of the present invention. As shown in FIG. 5, main image fetching circuit 410 includes horizontal counter 502, vertical counter 504, comparison circuitry 506, and register 510. As discussed above, main image fetching circuit 410 is accessed to determine a relative position of a pixel within an image region as the pixel is being output for display. To compute the relative position of the pixel within the image region, the pixel is tracked by one or more counters. In one embodiment, main image fetching circuit 410 includes horizontal counter 502 to track the pixel position along a horizontal direction and vertical counter 504 to track the pixel position along a vertical direction. It should be appreciated that an image is refreshed on a display from left to right in the horizontal direction and from top to bottom in the vertical direction. To track the pixels, horizontal counter 502 and vertical counter 504 are incremented by one when transitioning to a next pixel for display. For example, as a first pixel is being output along a horizontal line from left to right, horizontal counter 502, which initially has a zero count value, increments by one. Thus, the relative position of the first pixel along the horizontal direction is identified by a count value of one. When transitioning to an adjacent pixel column for display along the same horizontal line, horizontal counter 502 increments from a count value of one to a count value of two. As such, the relative position of the adjacent pixel along the same horizontal line is identified by a count value of two. In this way, horizontal counter 502 keeps track of each pixel along the horizontal direction. Similarly, vertical counter 504 keeps track of each pixel using the same method described above when transitioning to a next pixel row within an image region. In effect, incrementing horizontal counter 502 and vertical counter 504 computes the relative position or X and Y coordinates of the pixels within the image region. Additionally, the counters may not necessarily increment by a value of one, but may increment by any suitable values (e.g., two, three, four, etc.). In another embodiment, main image fetching circuit 410 may include one counter to track the pixels. Here, as each pixel is being displayed, the counter increments by one. As such, each pixel is identified by a unique count value. As is known to those skilled in the art, a separate calculation is then applied to convert the unique count values to X and Y coordinates of the pixels within the image region.

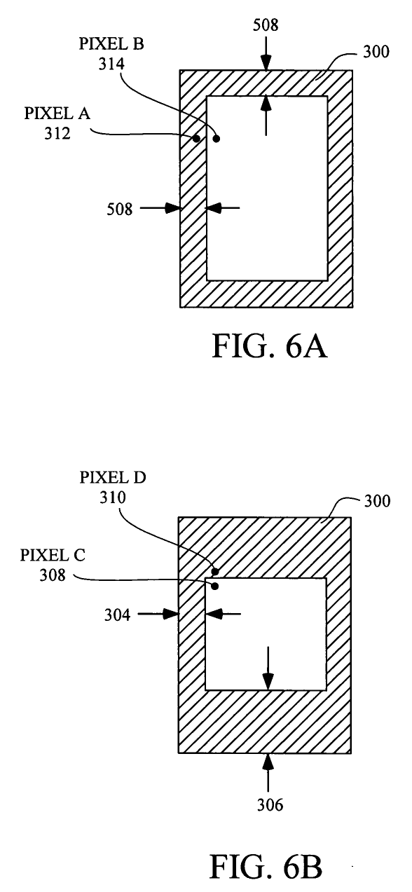

In addition, main image fetching circuit 410 includes comparison circuitry 506 and register 510 to determine whether the pixels are located within a border region. In one embodiment, comparison circuitry 506 includes logic for comparing the relative position of the pixels with border region width 508 (e.g., comparators). Border region width 508 is a value that specifies a thickness of the border region and, in one embodiment, is stored in register 510. Alternatively, in another embodiment, border region width 508 may be stored in a central register located outside of main image fetching circuit 410. For detailed explanation of the logic for comparing the relative position of the pixels with border region width 508, reference is made to FIG. 6A which illustrates a border region with a uniform border region width, in accordance with one embodiment of the present invention.

As shown in FIG. 6A, border region 300 has width 508 that is uniform. In other words, the thickness of border region 300 remains the same along the horizontal and vertical direction. To determine whether a pixel is located within border region 300, the relative position of the pixel is compared with border region width 508. For exemplary purposes, border region width 508 is specified as ten pixels. Pixel A 312 has a count value of five along a horizontal direction. A comparison shows that the count value of five is less than border region width 508 of ten pixels. As a result, Pixel A 312 is located in border region 300. On the other hand, Pixel B 314 has a count value of eleven along the same horizontal line. A comparison shows that the count value of eleven is greater than border region width 508 of ten pixels. As such, Pixel B 314 is not located in border region 300. The above-described exemplary illustration describes the comparison of a pixel along a horizontal direction. Of course, the same method may also be applied for comparison along a vertical direction.

In another embodiment, border region width may not be uniform. FIG. 6B illustrates a border region with non-uniform border region width, in accordance with another embodiment of the present invention. As shown in FIG. 6B, border region 300 has different vertical width 306 and horizontal width 304. Specifically, there are two separate border widths, namely horizontal border width 304 and vertical border width 306, that specify the thickness of border region 300 along the horizontal direction and along the vertical direction, respectively. As shown in FIG. 6B, vertical width 306 is thicker than horizontal width 304. It should be appreciated that both horizontal border width 304 and vertical border width 306 may either be stored in a register within the main image fetching circuit or stored in a central register outside the main fetching circuit.

To determine whether a pixel is located within border region 300 with non-uniform widths, the relative position of the pixel is compared with horizontal border width 304 and vertical border width 306. For example, as shown in FIG. 6B, vertical border width 306 is specified as thirty pixels and horizontal border width 304 is specified as ten pixels. Pixel D 310 has a relative position of twelve pixels (i.e., count value of twelve) along the horizontal direction and twenty eight pixels along the vertical direction. A comparison shows that relative position of twelve pixels along the horizontal direction is greater than horizontal border width 304 of ten pixels. However, another comparison along the vertical direction shows that the relative position of twenty eight pixels is less than vertical border width 306 of thirty pixels. As such, Pixel D 310 is located within border region 300. On the other hand, Pixel C 308 also has a relative position of twelve pixels along the horizontal direction. However, the relative position along the vertical direction is thirty two pixels. A comparison shows that relative position of twelve pixels along the horizontal direction is greater than horizontal border width 304 of ten pixels. Another comparison along the vertical direction shows that relative position of thirty two pixels is greater than vertical border width 306 of thirty pixels. As such, Pixel C 308 is located outside border region 300. It should be appreciated that border region 300 may have up to four different widths for each side of the border region, in accordance with one embodiment of the present invention. As a result, up to four different border region widths may be used for comparing the relative positions of pixels to determine whether the pixels are located within border region 300. The comparison circuitry includes logic gates, comparators, etc., required to achieve the functionality described above.

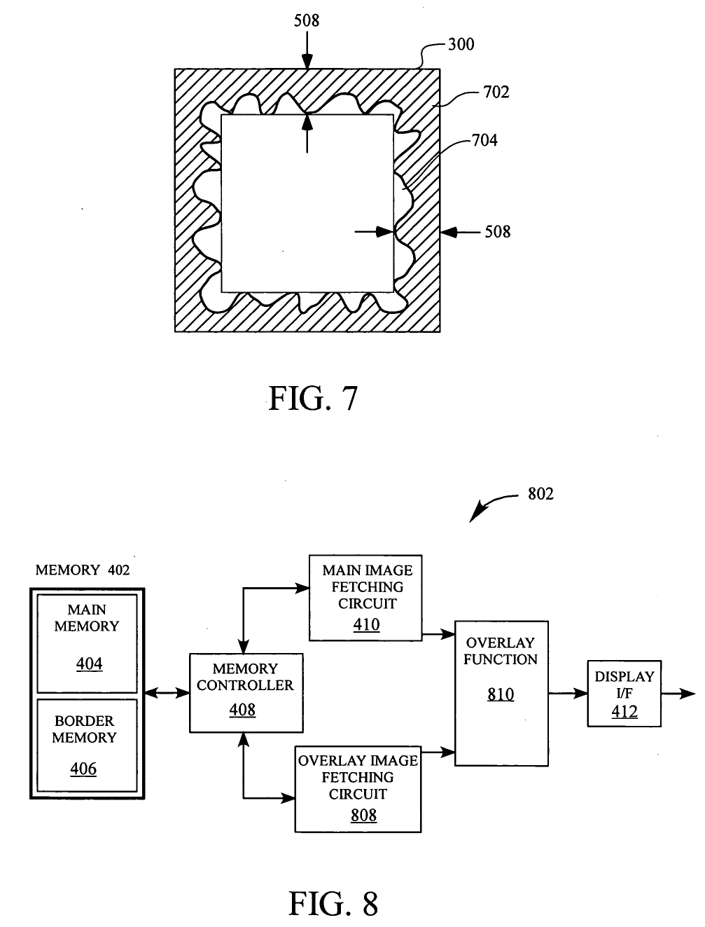

The embodiments described herein are also capable of supporting border regions that have non-linear edges. FIG. 7 illustrates a border region with non-linear edges, in accordance with one embodiment of the present invention. Essentially, non-linear edges are made possible by the inclusion of transparent pixels. As shown in FIG. 7, border region 300 is defined by border region width 508 that includes visible parts 702 and transparent parts 704 of the border region. Transparent parts 704 are comprised of pixels that are transparent. By mixing transparent pixels with visible pixels, non-linear edges may be defined. As is known to those skilled in the art, each pixel is defined by a number of bits (e.g., eight, sixteen bits, etc.) and the bits define whether the pixel is transparent. For example, a transparency register has a particular eight bit value. If an eight bit value of a pixel matches the transparency register, then the pixel is transparent.

FIG. 8 is a detailed schematic diagram of a display controller that can incorporate non-linear border edges, in accordance with one embodiment of the present invention. Similar to the display controller of FIG. 4, display controller 802 includes memory 402, memory controller 408, main image fetching circuit 410, and display interface 412. However, display controller 802 of FIG. 8 also includes overlay image fetching circuit 808 and overlay function module 810. In one embodiment, memory 402 included within display controller 802 has separate main memory 404 and border memory 406 sections. Main memory 404 stores image pixels and border memory 406 stores border pixels.

Main image fetching circuit 410 also includes the logic for fetching an image pixel or a border pixel dependent upon the relative position of a pixel as discussed above. However, in this embodiment, when the pixel is located in the border region, both the border pixel and the image pixel are fetched. Thereafter, the border pixel is analyzed to determine whether the border pixel is transparent. Here, the value of the border pixel determines transparency as described above. If the border pixel is not transparent, then the border pixel is selected for display within the border region. If the border pixel is transparent, then the image pixel is selected instead for display within the border region.

For example, a relative position of a pixel within an image region is first computed, and the relative position is then compared with a border region width to determine whether the pixel is located in the border region. If the relative position of the pixel is in the image region, then main image fetching circuit 410 fetches an image pixel from main memory 404 for display. However, if the relative position of the pixel is in the border region, then main image fetching circuit 410 fetches the image pixel from main memory 404. At the same time, overlay image fetching circuit 808 fetches the border pixel from border memory 406. Subsequently, overlay function module 810 analyzes the border pixel to determine whether the border pixel is transparent. If the border pixel is not transparent, overlay function module 810 selects the border pixel for display within the border region. If the border pixel is transparent, overlay function module 810 selects the image pixel instead for display within the border region.

Alternatively, the display controller of FIG. 4 may also be configured to incorporate non-linear border edges, in accordance with one embodiment of the present invention. Returning to FIG. 4, a relative position of a pixel is first computed, and the relative position is compared with a border region width to determine whether the pixel is located in the border region. If the relative position of the pixel is in an image region, then main image fetching circuit 410 fetches an image pixel from main memory 404 for display. However, if the relative position of the pixel is in the border region, then main image fetching circuit 410 first fetches the border pixel from border memory 406 and then analyzes the border pixel, i.e., the value associated with the border pixel, to determine whether the border pixel is transparent. If the border pixel is not transparent, then main image fetching circuit 410 sends the border pixel to display interface 412 for display. However, if the border pixel is transparent, main image fetching circuit 410 then fetches image pixel from border memory 406 for display.

In summary, the above described invention provides an apparatus, display controllers, and hardware implemented methods to incorporate a border region within an image region. When compared to the conventional method of storing an entire overlay, storing a portion of the overlay that comprises the border region and fetching the pixels accordingly reduce memory space and, in one embodiment, eliminate extra circuitry to process transparent pixels. Thus, the reduction of memory space and the elimination of extra circuitry require less processing power and bandwidth. As a result, small, portable devices with limited power, memory, and computing capability incorporating the above described invention can adequately process and incorporate borders.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

1. A hardware implemented method for incorporating a border region within an image region, comprising the method operations of:
computing a relative position of a pixel within the image region;
comparing the relative position of the pixel with a border region width to determine whether the pixel is located in the border region;
fetching a border pixel from a border memory if the relative position of the pixel is in the border region; and
fetching an image pixel from a main memory if the relative position of the pixel is in the image region.

2. The hardware implemented method of claim 1, further comprising:
outputting the fetched pixel to a display.

3. The hardware implemented method of claim 1, wherein the method operation of fetching the border pixel from the border memory if the relative position of the pixel is in the border region includes,
fetching the image pixel from the main memory if the border pixel is transparent; and
outputting the image pixel to a display.

4. The hardware implemented method of claim 1, wherein the method operation of fetching the border pixel from the border memory if the relative position of the pixel is in the border region includes,
fetching the image pixel from the main memory;
selecting the border pixel for display if the border pixel is not transparent; and
selecting the image pixel for display if the border pixel is transparent.

5. The hardware implemented method of claim 1, wherein the method operation of computing the relative position of the pixel within the image region includes,
tracking the pixel along a horizontal position and along a vertical position.

6. The hardware implemented method of claim 5, wherein the border region width includes a horizontal border width and a vertical border width.

7. The hardware implemented method of claim 6, wherein the method operation of comparing the relative position of the pixel with the border region width includes,
comparing the horizontal position with the horizontal border width; and
comparing the vertical position with the vertical border width.

8. A display controller for incorporating a border region within an image region, comprising:
a main memory configured to store an image pixel;
a border memory configured to store a border pixel;
a memory controller configured to fetch the image pixel from the main memory and to fetch the border pixel from the border memory; and
a main image fetching circuit in communication with the memory controller, the main image fetching circuit including,
logic for computing a relative position of a pixel within the image region,
logic for fetching the border pixel from the border memory if the relative position of the pixel is in the border region, and
logic for fetching the image pixel from the main memory if the relative position of the pixel is in the image region.

9. The display controller of claim 8, wherein the main image fetching circuit further includes,
logic for comparing the relative position of the pixel with a border region width to determine whether the pixel is located in the border region.

10. The display controller of claim 8, further comprising:
a display interface in communication with the main image fetching circuit, the display interface being configured to interface with a display.

11. The display controller of claim 8, wherein each of the main and border memories is selected from the group consisting of a static random access memory (SRAM) and a dynamic random access memory (DRAM).

12. An apparatus for incorporating a border region within an image region, comprising:
a display controller including,
circuitry for accessing a main image fetching circuit to determine a relative position of a pixel within the image region, and
circuitry for fetching an image pixel or a border pixel dependent upon the relative position of the pixel;
a central processing unit (CPU) in communication with the display controller; and
a display in communication with the display controller, the display enabling the display of the image region.

13. The apparatus of claim 12, further comprising:
a memory in communication with the CPU.

14. The apparatus of claim 12, wherein the display is selected from the group consisting of a liquid crystal display (LCD), a thin-film transistor (TFT) display, a cathode ray tube (CRT) monitor, and a television.

15. A hardware implemented method for incorporating a border region within an image region, comprising the method operations of:
accessing a main image fetching circuit to determine a relative position of a pixel within the image region; and
fetching an image pixel or a border pixel dependent upon the relative position of the pixel.

16. The hardware implemented method of claim 15, further comprising:
incrementing a counter of the main image fetching circuit to determine a current relative position of a next pixel within the image region; and
fetching one of the image pixel or the border pixel dependent upon the current relative position of the next pixel.

17. The hardware implemented method of claim 16, wherein the method operation of incrementing the counter of the main image fetching circuit includes,
incrementing a horizontal counter when transitioning to a next pixel column within the image region; and
incrementing a vertical counter when transitioning to a next pixel row within the image region.

18. The hardware implemented method of claim 15, further comprising:
storing the image pixels; and
storing the border pixels, the border pixels representing a portion of an area of the image pixels.

19. The hardware implemented method of claim 15, wherein the method operation of fetching the image pixel or the border pixel dependent upon the relative position of the pixel includes,
fetching the border pixel from a border memory if the relative position of the pixel is in the border region; and
fetching the image pixel from a main memory if the relative position of the pixel is in the image region.

20. The hardware implemented method of claim 19, wherein the method operation of fetching the border pixel from the border memory if the relative position of the pixel is in the border region includes,
fetching the image pixel from the main memory if the border pixel is transparent; and
outputting the image pixel to a display.

21. The hardware implemented method of claim 19, wherein the method operation of fetching the border pixel from the border memory if the relative position of the pixel is in the border region includes,
fetching the image pixel from the main memory;
selecting the border pixel for display if the border pixel is not transparent; and
selecting the image pixel for display if the border pixel is transparent.
